(19) United States
(12) Patent Application Publication
(10) Pub. No.: US 2024/0126904 A1
(43) Pub. Date: Apr. 18, 2024

(54) Systems and Methods for Managing Access to Confidential Data

(71) Applicant: STATE FARM MUTUAL AUTOMOBILE INSURANCE COMPANY, Bloomington, IL (US)

(72) Inventor: Aaron Williams, Congerville, IL (US)

(21) Appl. No.: 17/980,201

(22) Filed: Nov. 3, 2022

Related U.S. Application Data
(60) Provisional application No. 63/417,475, filed on Oct. 19, 2022.
(60) Provisional application No. 63/416,291, filed on Oct. 14, 2022.

(51) Int. Cl. G06F 21/62; G06F 21/31; G06F 21/60; H04L 9/32

(52) U.S. Cl. CPC G06F 21/6218; G06F 21/31; G06F 21/602; H04L 9/3213; H04L 2209/60

(57) ABSTRACT

The present systems and methods relate generally to using non-fungible tokens (NFTs) to manage confidential data. In some embodiments, confidential data is obtained. An NFT may then be minted representing availability of the confidential data. The NFT may be transferred to an authorized party to provide access to the confidential data and to indicate that the authorized party received the confidential data. The systems and methods may provide real-time management of data permissions related to confidential data. The systems and methods may implement cognitive computing for recommendation generation based on the confidential data.

### CROSS REFERENCE TO RELATED APPLICATIONS

The present application claims priority to U.S. Provisional patent application S/Ns: 63/417,475, filed Oct. 19, 2022, and 63/416,291, filed Oct. 14, 2022, the entire disclosures of which are incorporated herein by reference.

The present application is related to U.S. Provisional patent application S/Ns: 63/417,486, filed Oct. 19, 2022, and 63/416,293, filed Oct. 14, 2022, the entire disclosures of which are incorporated herein by reference.

### FIELD

The present disclosure generally relates to managing access to confidential data. More particularly, the present disclosure relates to systems and methods for managing access to confidential data using non-fungible tokens (NFTs).

### BACKGROUND

Current systems for managing access to confidential data (e.g., consumer confidential data, business confidential data, etc.) have certain drawbacks. For instance, certain systems may expose the confidential data to unauthorized access when the confidential data is stored in a computer-readable medium. In another example, certain confidential data management systems are not robust because a single failure may cause the entire system to collapse. In yet another example, certain confidential data management systems may expose the confidential data to unauthorized access when the confidential data is electronically transmitted from one device to another.

The systems and methods disclosed herein provide solutions to these problems and may provide solutions to other drawbacks of conventional techniques for managing confidential data.

### SUMMARY

The present embodiments relate to, inter alia, using non-fungible tokens (NFTs) to manage confidential data. In certain embodiments, a NFT may be minted to represent ownership of associated confidential data. The NFT may be transferred amongst users when the confidential data is transferred to prove receipt and ownership of the confidential data. The NFT may also be used to track interactions with the confidential data.

Furthermore, there may be a service to verify that the title holder of the confidential data matches the NFT owner—such as use of two-factor authentication for both the seller and buyer when a sale or transfer of the confidential data is about to happen to ensure that the NFT reflects true ownership and to prevent fraud.

In one aspect, a computer-implemented method for using NFTs to limit access to confidential data may be provided. The method may be implemented via one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the method may include obtaining, via one or more processors, identification information of confidential data. The method may also include packaging, via the one or more processors, an NFT on a distributed ledger. The NFT may represent ownership of the confidential data and including the identification information of the confidential data. The method may further include receiving, via the one or more processors, an indication providing access to at least one specific stakeholder for specific confidential data within the confidential data. The method may yet further include curating, via the one or more processors, availability of the specific confidential data to the at least one specific stakeholder in response to receiving the indication providing availability of the specific confidential data. The method may include additional, less, or alternative actions, including those discussed elsewhere herein.

In another aspect, a computer system for using NFTs to limit access to confidential data may be provided. The computer system may include one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the computer system may include one or more local or remote processors, transceivers, and/or sensors configured to obtain identification information of confidential data. The system may also be configured to mint an NFT on a distributed ledger. The NFT may represent ownership of the confidential data and include the identification information of the confidential data. The system may be also be configured to receive an indication providing access to at least one specific stakeholder for specific confidential data within the confidential data. The system may also be configured to curate availability of the specific confidential data to at least one specific stakeholder in response to receiving the indication providing availability of the specific confidential data. The system may include additional, less, or alternative functionality, including that discussed elsewhere herein.

In yet another aspect, a non-transitory computer-readable medium including computer-executable instructions stored therein that, when executed by the one or more processors, may cause the one or more processors to use NFTs to limit access to confidential data. Execution of the computer-executable instructions may cause the one or more processors to obtain identification information of confidential data. Further execution of the computer-executable instructions may also cause the one or more processors to mint an NFT on a distributed ledger. The NFT may represent ownership of the confidential data and include the identification information of the confidential data. Further execution of the computer-executable instructions may further cause the one or more processors to receive an indication providing access to at least one specific stakeholder for specific confidential data within the confidential data. Further execution of the computer executable instructions may also cause the one or more processors to curate availability of the specific confidential data to the at least one specific stakeholder in response to receiving the indication providing availability of the specific confidential data. The instructions may direct additional, less, or alternative functionality, including that discussed elsewhere herein.

In one aspect, a computer-implemented method for using NFTs for real-time management of data permissions may be provided. The method may be implemented via one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the method may include obtaining, via one or more processors, identification information of confidential data. The method may also include creating, via the one or more processors, a third-party profile via a data permissions platform. The method may further include listing, via the one or more processors, user approved confidential data with the third-party profile in response to creation of the third-party profile. The method may yet further include receiving, via the one or more processors, a data use incentive offer from the third-party in exchange for specific confidential data availability. The method may also include minting, via the one or more processors, an NFT on a distributed ledger. The NFT may represent ownership of the confidential data and include the identification information of the specific confidential data. The method may further include transferring, via the one or more processors, the NFT to the third-party in exchange for the data use incentive in response to the user accepting the data use incentive. The method may include additional, less, or alternative actions, including those discussed elsewhere herein.

In another aspect, a computer system for using NFTs to manage data permissions in real-time may be provided. The computer system may include one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the computer system may include one or more local or remote processors, transceivers, and/or sensors configured to obtain identification information of confidential data. The system may be also configured to create a third-party profile via a data permissions platform. The system may be further configured to list user approved confidential data with the third-party profile in response to creation of the third-party profile. The system may be yet further configured to receive a data use incentive offer from the third-party in exchange for specific confidential data availability. The system may be also configured to mint an NFT on a distributed ledger. The NFT may represent ownership of the confidential data and include the identification information of the specific confidential data. The system may be further configured to transfer the NFT to the third-party in exchange for the data use incentive in response to the user accepting the data use incentive. The system may include additional, less, or alternative functionality, including that discussed elsewhere herein.

In yet another aspect, a non-transitory computer-readable medium may include computer-executable instructions stored therein that, when executed by one or more processors, may cause the one or more processors to use NFTs to manage data permissions in real-time. Execution of the instructions by the one or more processors may cause the one or more processors to obtain identification information of confidential data. Further execution of the instructions may also cause the one or more processors to create a third-party profile via a data permissions platform. Further execution of the instructions may further cause the one or more processors to list user approved confidential data with the third-party profile in response to creation of the third-party profile. Further execution of the instructions may yet further cause the one or more processors to receive a data use incentive offer from the third-party in exchange for specific confidential data availability. Further execution of the instructions may also cause the one or more processors to mint an NFT on a distributed ledger, the NFT representing ownership of the confidential data and including the identification information of the specific confidential data. Further execution of the instructions may also cause the one or more processors to transfer the NFT to the third-party in exchange for the data use incentive in response to the user accepting the data use incentive. The instructions may direct additional, less, or alternative functionality, including that discussed elsewhere herein.

In one aspect, a computer-implemented method for using cognitive computing for recommendation generation based on confidential data and corresponding NFTs may be provided. The method may be implemented via one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the method may include obtaining, via one or more processors, at least one of: confidential data, interaction permissions for confidential data, or interactions with confidential data. The method may also include generating, via the one or more processors, at least one of: a confidential data interaction security alert, a recommendation, an incentive, a new confidential data interaction permission, or new business based upon the at least one of: confidential data, interaction permissions for confidential data, or interactions with confidential data and using cognitive computing. The method may include additional, less, or alternative actions, including those discussed elsewhere herein.

In another aspect, a computer system to generate recommendations based on confidential data and corresponding NFTs using cognitive computing may be provided. The computer system may include one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the computer system may include one or more local or remote processors, transceivers, and/or sensors configured to obtain at least one of: confidential data, interaction permissions for confidential data, or interactions with confidential data. The system may also be configured to generate at least one of: a confidential data interaction security alert, a recommendation, an incentive, a new confidential data interaction permission, or new business based upon the at least one of: confidential data, interaction permissions for confidential data, or interactions with confidential data and using cognitive computing. The system may include additional, less, or alternative functionality, including that discussed elsewhere herein.

In yet another aspect, a non-transitory computer-readable medium may include computer-executable instructions stored therein that, when executed by one or more processors, may cause the one or more processors to generate recommendations based on confidential data and corresponding NFTs using cognitive computing. Execution of the instructions by the one or more processors may cause the one or more processors to obtain at least one of: confidential data, interaction permissions for confidential data, or interactions with confidential data. Further execution of the instructions may also cause the one or more processors to generate at least one of: a confidential data interaction security alert, a recommendation, an incentive, a new confidential data interaction permission, or new business based upon the at least one of: confidential data, interaction permissions for confidential data, or interactions with confidential data and using cognitive computing. The instructions may direct additional, less, or alternative functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computer system for using NFTs to manage confidential data.

FIG. 2A illustrates an exemplary confidential data management device for using NFTs to manage confidential data.

FIG. 2B illustrates an exemplary computer-implemented method of using NFTs to manage confidential data.

FIG. 2C illustrates an exemplary computer-implemented method of using NFTs to manage confidential data.

FIG. 3A illustrates an exemplary confidential data management device for using NFTs to manage confidential data.

FIG. 3B illustrates an exemplary computer-implemented method of using NFTs to manage confidential data.

FIG. 3C illustrates an exemplary computer-implemented method of using NFTs to manage confidential data.

FIG. 4 illustrates exemplary network nodes and an exemplary distributed ledger.

FIG. 5 illustrates exemplary network nodes, and an exemplary transaction flow on a distributed ledger network.

FIG. 6 illustrates exemplary components of a network node on a distributed ledger network.

FIG. 7 illustrates an exemplary blockchain having blocks of transactions.

FIG. 8 depicts an exemplary transaction in a distributed ledger network for managing confidential data using NFTs.

FIG. 9 depicts an exemplary smart contract state in a distributed ledger network for managing confidential data using NFTs.

FIG. 10A illustrates an exemplary confidential data management device for using NFTs to manage confidential data.

FIG. 10B illustrates an exemplary computer-implemented method of using NFTs to manage confidential data.

While the systems and methods disclosed herein are susceptible of being embodied in many different forms, the systems and methods are shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein are not limited in application to the details of construction and to the arrangements of components set forth above and below, illustrated in the drawings, or as described in the examples. Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

The present disclosure generally relates to, inter alia, using non-fungible tokens (NFTs) to manage confidential data. The systems and methods disclosed herein may, for example, provide control of data dissemination by applying time or use-limiting logic to access rights via NFTs associated with confidential business or customer data. The systems and methods may limit external user access to the data, while maintaining a private record of the data and data access by any external users. The systems and methods may be particularly useful for sending data (e.g., confidential business data, etc.) to regulators or others for audit purposes, where the external users only need access to the data for a limited time.

Alternatively, or additionally, the systems and methods of the present disclosure may provide customer permissions to access various types or sets of confidential data. The permissions may be, for example, uniformly managed in real time using a permission NFT as a modifiable key to access customer data in a digital data vault. A permission NFT may also permit access to different subsets of confidential data to different data consumers. The access to confidential data may be assigned in exchange for some incentive (e.g., a payment, a reward, access to other information or software functionalities, etc.). A permissions tool may provide, for example, a user interface to manage such permissions. More broadly, the permissions tool may provide a platform for minting, storing, and transferring permission NFTs.

As another alternative, or addition, the systems and methods of the present disclosure may implement cognitive computing methods to analyze the confidential data and/or interactions with the confidential data to, for example, generate recommendations for businesses, customers, insurers, etc. The recommendations may include new business offerings for companies to consider. Alternatively, or additionally, the recommendations may include new confidential data permission settings for customers.

Some embodiments disclosed herein advantageously manage confidential data using NFTs on a blockchain. For example, an NFT may be minted representing ownership and/or possession of confidential data. When a receiving party (e.g., a regulator, a customer, a user, etc.) receives the confidential data, the NFT may be transferred to the receiving party to indicate that the receiving party possesses (e.g., has received) and/or now owns the confidential data.

Furthermore, the techniques described herein may provide a service to verify that the title holder of the confidential data matches the NFT owner. For example, the service may use two-factor authentication for both the seller and buyer when a sale or transfer of the shipping container or cargo items is about to happen to ensure that the NFT reflects true ownership and to prevent fraud.

The systems and methods described herein have technical advantages over prior systems. For example, prior confidential data management systems may rely on two separate databases (e.g., a database of the transferring party and a database of the receiving party); however, this presents a problem when there is a discrepancy between information in each database (e.g., one database indicates that the confidential data has been received, but the other database indicates that it has not yet been received). The systems and methods described herein provide an elegant solution to this by minting NFTs that are specific to one or more sources of confidential data.

In another example, prior confidential data management systems did not always accurately indicate who the true title holder of a confidential data was. By minting an NFT specifically in response to authentication of a true title holder, some embodiments advantageously, accurately, and reliably indicate the true title holder while maintaining as confidential the confidential data. In this regard, this specific use of an NFT further makes the disclosed confidential data management system more tamper-resistant than prior systems.

A blockchain (also referred to herein as a distributed ledger) is a way of achieving a distributed consensus on the validity or invalidity of information in the chain. In other words, the blockchain provides a decentralized trust to participants and observers. As opposed to relying on a central authority, a blockchain is a decentralized database in which a transactional record of changes to the ledger is maintained and validated by each node of a peer-to-peer network. The distributed ledger is comprised of groupings of transactions organized together into a “block,” and ordered sequentially as a chain of such blocks (thus the term “blockchain”). Nodes may join and leave the blockchain network over time and may obtain blocks that were propagated while the node was gone from peer nodes. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirement and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes that the validating node is aware of. If all the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable. Third party intermediaries who assist in the resolution of subrogation claims may thus be disintermediated from the process by a decentralized blockchain.

The validation activities of nodes applying consensus rules on a blockchain network may take various forms. In one implementation, the blockchain may be viewed as a shared spreadsheet that tracks data such as the ownership of assets. In another implementation, the validating nodes execute code contained in “smart contracts” and distributed consensus is expressed as the network nodes agreeing on the output of the executed code.

Blockchains may be deployed in a public, decentralized, and permissionless manner meaning that any party may view the distributed ledger, submit new information to be added to the ledger, or join the network as a validating node. Other blockchains are private that keep chain data private among a group of entities authorized to participate in the blockchain network. Yet other blockchains are permissioned, which may be a hybrid of a public and a private blockchain. In some scenarios, private blockchains are maintained by a single entity, whereas permissioned blockchains include multiple authorized entities to make changes to the blockchain.

Still other advantages will be further explained in the following disclosure.

### Exemplary System for Using NFTs to Manage Confidential Data

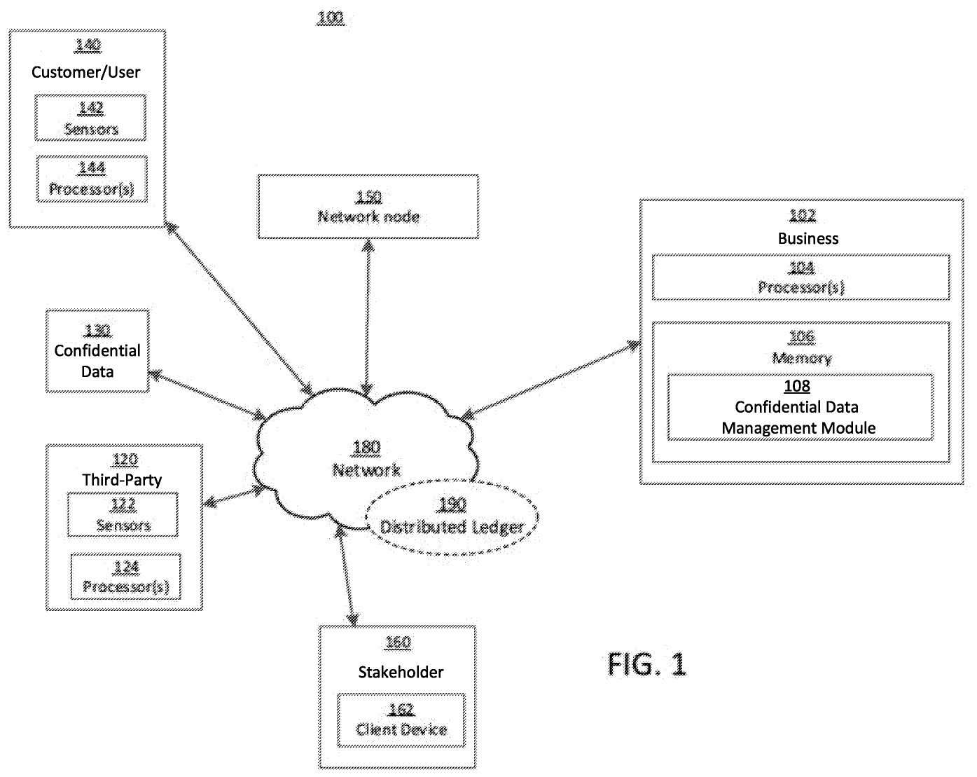

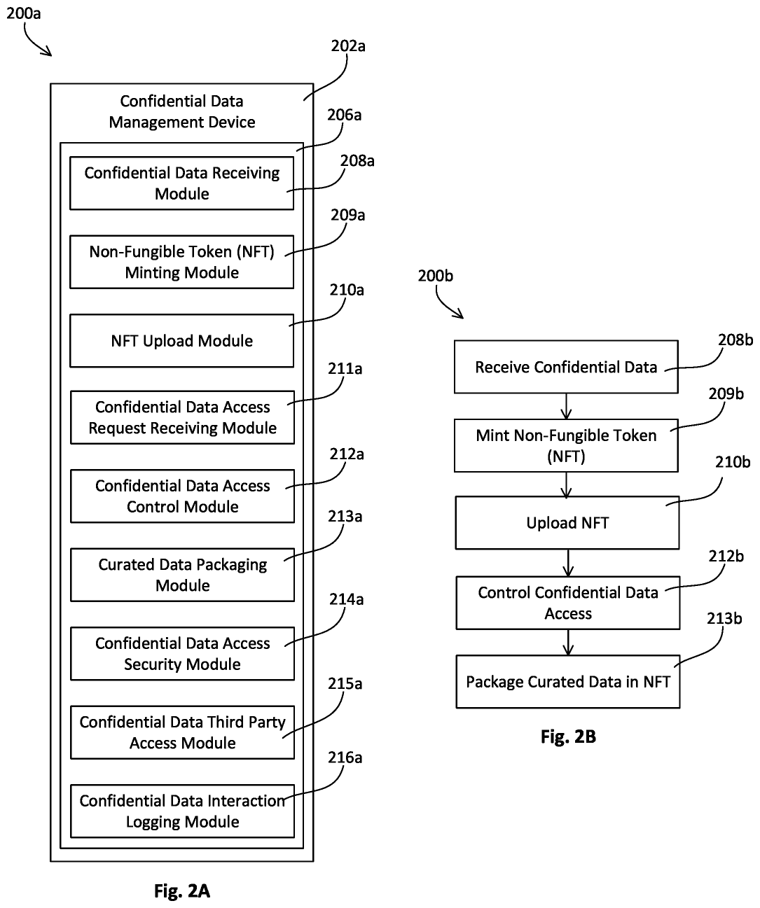

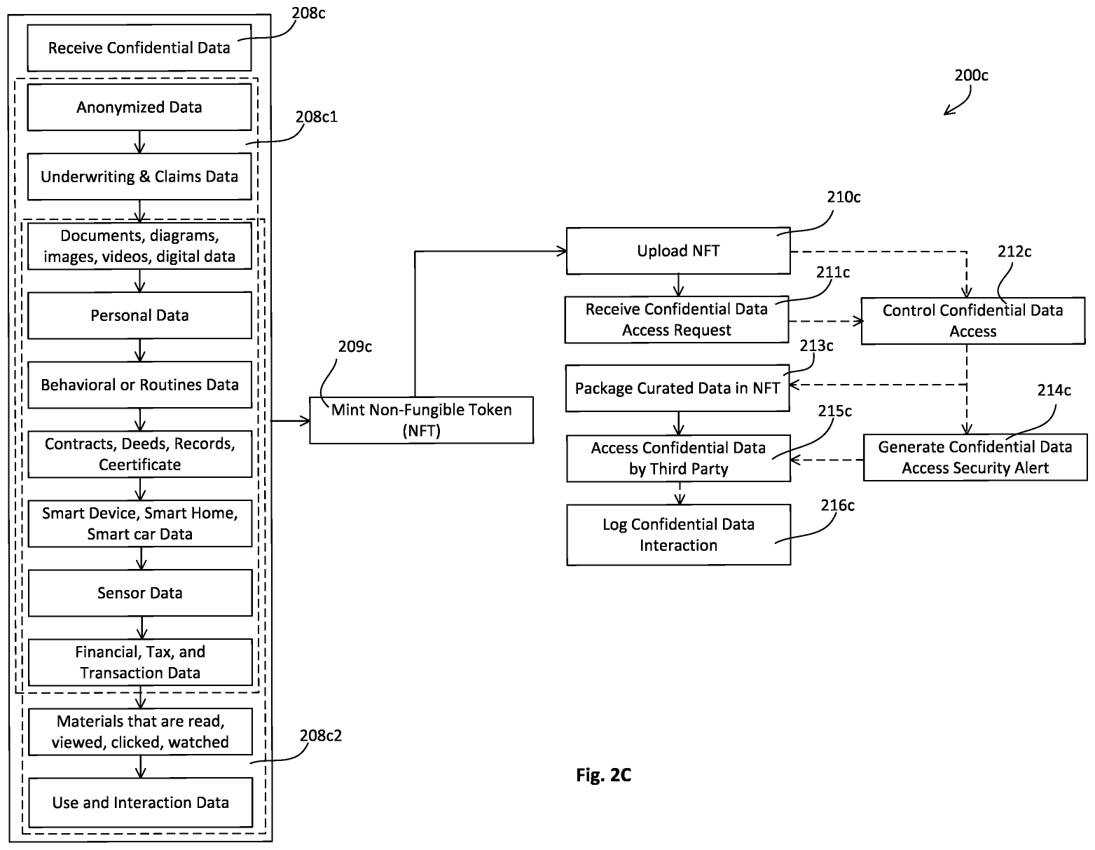

FIG. 1 shows an exemplary computer system 100 for using NFTs to manage confidential data (e.g., an encrypted blockchain-based confidential data portal, an encrypted blockchain-based confidential data permissions portal, a metaverse, etc.). The example system 100 may include network nodes 102, 150, receiving party 120, confidential data 130, transferring party 140, and title holder 160, which may be communicatively connected through a network 180 as described below. According to embodiments, the network nodes 102, 150 may be a combination of hardware and software components, also as described in more detail below with reference to FIGS. 2A-9. The network nodes 102, 150 may each include a memory 106, one or more processors 104, such as a microcontroller or a microprocessor, and other components not shown in FIG. 1 (e.g., a random-access memory (RAM), and/or an input/output (I/O) circuit), all of which may be interconnected via an address/data bus.

The memory 106 and/or RAM may store various applications for execution by the one or more processors 104. For example, a user interface application may provide a user interface to the network node 102, which user interface may, for example, allow the system administrator to configure, troubleshoot, and/or test various aspects of the node's operation.

The memory 106 may be tangible, non-transitory memory and may include any types of suitable memory modules, including RAM, read-only memory (ROM), flash memory, other types of persistent memory, etc. The memory 106 may store, for example, instructions executable on the processors 104 for a confidential data management module 108.

The confidential data management module 108 may validate changes to the blockchain (e.g., when a new transaction and/or block is created) according to a set of consensus rules. The consensus rules depend on the information being tracked by the blockchain and may include rules regarding the chain itself. For example, a consensus rule may require that the originator of a change supply a proof-of-identity such that only approved entities may originate changes to the chain. Consensus rules may include a mechanism to determine the order in which new blocks are added to the chain (e.g., through a proof-of-work system, proof-of-stake, etc.).

The confidential data management 108 may append distributed ledger data to the distributed ledger if the distributed ledger data satisfies the consensus rules by generating a new block of validated transactions to include in the distributed ledger 190 and/or by broadcasting a block of transactions to other network nodes. Otherwise, the validator module 108 may disregard any distributed ledger data that does not satisfy the consensus rules, and the distributed ledger data is not propagated to other network nodes. For example, the distributed ledger 190 may include NFTs that represent ownership and/or possession of the confidential data 130, and may be transferred to indicate ownership and/or possession of the confidential data 130.

In another implementation, network nodes 102, 150 on the distributed ledger 190 are configured to maintain a state database and execute code in smart contracts deployed by network participants. A smart contract on the distributed ledger 190 may expose methods and maintain the state of data relating to minting and/or transferring NFTs representing ownership and/or possession of confidential data 130.

The confidential data 130 may be any kind of business confidential data 208c1 or customer confidential data 208c2. Examples of the confidential data 130 include a document, a diagram, an image, a video, digital data, materials that are read, materials that are viewed, materials that are clicked, materials that are watched, materials that are used, interaction data, personal data, behavioral data, routine data, a contract, a deed, a record, a certificate, smart device data, smart home data, smart car data, sensor data, financial data, tax data, or transaction data, etc. Furthermore, in some embodiments, the confidential data 130 may include business confidential data and/or consumer confidential data, etc.

The receiving party 120 may be any entity that receives the confidential data 130. For example, the receiving party 120 may be a third-party, a business, a stakeholder, etc. In some embodiments, the receiving party is the buyer of the confidential data 130.

Furthermore, in some embodiments, the receiving party 120 itself may be a network node on the distributed ledger 190. For example, the receiving party 120 may be a business including one or more processors 124 which may be a network node on the distributed ledger 190.

The transferring party 140 may be any party that transfers the confidential data 130. For example, the transferring party 140 may be a stakeholder, a person, etc. In some embodiments, the transferring party 140 is a seller of the confidential data 130.

Furthermore, in some embodiments, the transferring party 140 itself may be a network node on the distributed ledger 190. For example, the transferring party 140 may be a truck including one or more processors 144 which may be a network node on the distributed ledger 190.

Stakeholder 160 may be a title holder of the confidential data 130. The title holder 160 may have a client device 162, which may comprise, by way of example, a tablet computer, a cell phone, a personal digital assistant (PDA), a mobile device smart-phone also referred to herein as a “mobile device,” a laptop computer, a desktop computer, a portable media player, a wearable computing device, smart glasses, augmented reality glasses, virtual reality headset, smart watches, phablets, other smart devices, devices configured for wired or wireless RF (Radio Frequency) or optical communication, etc. In some embodiments, a smart contract mints an NFT in response to the title holder 162 completing two-factor authentication using the client device 162; and the network node 102, 150 may then record the transaction. In some embodiments, the titleholder 160 may be a buyer or seller of the confidential data 130.

The client device 162 may include a memory, one or more processors, such as a microcontroller or a microprocessor, and other components (e.g., a display, a communication unit, a user-input device, a RAM, and/or an I/O circuit) not shown in FIG. 1, all of which may be interconnected via an address/data bus. The memory may include an operating system, a data storage, a plurality of software applications, and/or a plurality of software routines. The data storage may include data such as user profiles, application data for a plurality of applications, routine data for the plurality of routines, and/or other data necessary to interact with the network nodes 102, 150 through the network 180. In some embodiments, the one or more processors may also include, or otherwise be communicatively connected to, other data storage mechanisms (e.g., one or more hard disk drives, optical storage drives, solid state storage devices, etc.) that reside within the client device 162. The communication unit may communicate with the network nodes 102, 150 via any suitable wireless communication protocol network, such as a wireless telephony network (e.g., GSM, CDMA, LTE, etc.), a Wi-Fi network (802.11 standards), a WiMAX network, a Bluetooth network, etc. Furthermore, in some embodiments, the client device 162 itself may be a network node on the distributed ledger 190.

It will be appreciated that although only two network nodes 102, 150, one transferring party 140, one confidential data 130, one receiving party 120 and one title holder 160 are depicted in FIG. 1, any suitable number of network nodes 102, 150, any suitable number of transferring parties 140, any suitable number of confidential data 130, any suitable number of receiving parties 120, and any suitable number of title holders 160 may be included in the system.

The network nodes 102, 150, the transferring party 140, the confidential data 130, the receiving party 120, and/or the title holder 160 may communicate with each other via the network 180. The network 180 may be a proprietary network, a secure public Internet, a virtual private network and/or some other type of network, such as dedicated access lines, plain ordinary telephone lines, satellite links, a wireless telephony network, combinations of these, etc. Where the network 180 comprises the Internet, data communication may take place over the network 180 via an Internet communication protocol.

### Exemplary System and Method for Limiting Availability of Business Confidential Data

FIG. 2A illustrates an exemplary confidential data management device 202a. The confidential data management device 202a may be similar to, for example, the business device 102 of FIG. 1. The confidential data management device 202a may, for example, limit availability of business confidential data (e.g., business confidential data 208c1 of FIG. 2C, etc.).

The confidential data management device 202a may include a confidential data receiving module 208a, a non-fungible token (NFT) minting module 209a, an NFT upload module 210a, a confidential data access request receiving module 211a, a confidential data access control module 212a, a curated data packaging module 213a, a confidential data access security module 214a, a confidential data third party access module 215a, and a confidential data interaction module 216a, for example, stored on a memory 206a as a set of computer-readable instructions. At least a portion of the modules 208a-216a may be included within the confidential data management module 108 of FIG. 1.

FIG. 2B illustrates an exemplary computer-implemented method 200b for limiting availability of confidential data 208b. The method 200b may be implemented by a processor (e.g., processor(s) 104 of FIG. 1) executing, for example, at least a portion of modules 208a-216a of FIG. 2A. In particular, processor 104 may execute the confidential data receiving module 208a to cause the processor 104 to, for example, receive confidential data (block 208b). The confidential data may be, for example, business confidential data (e.g., a document, a diagram, an image, a video, digital data, anonymized data, underwriting and claims data, personal data, behavioral data, routine data, a contract, a deed, a record, a certificate, smart device data, smart home data, smart car data, sensor data, financial data, tax data, transaction data, etc.).

The processor 104 may execute the NFT minting module 209a to, for example, cause the processor 104 to mint an NFT based upon the confidential data (block 209b). For example, the processor 104 may package confidential data and descriptions in an NFT based upon confidential data and/or permissions to interact with the confidential data. Alternatively, or additionally, the processor 104 may package confidential data and descriptions in an NFT along with real-time permissions to interact with the confidential data. In some embodiments, the NFT may serve as a modifiable or revocable key to access the confidential data from one or more secure data stores. For example, the confidential data may be stored in a data vault that is continually updated with confidential data associated with a plurality of data-generating users (e.g., insurance customers, smart device users, or accounting systems of various businesses). Access to subsets of the data stored in such data vault may be controlled by various NFTs, such as by smart contract terms incorporated within or linked to the NFTs. Thus, access to the confidential data may be limited by conditional logic (e.g., based upon time, based upon number of access instances, or subject to adjustments or revocation of access by the title holder). In some such embodiments, each NFT is associated with a subset of the data in the data vault, thus providing access to the subset of data. In further embodiments, an NFT may include access credentials or authorization to access a plurality of subsets of data in the data vault. For example, an NFT associated with a data consumer may be updated to include access to data associated with a title holder upon acceptance of an offer of an incentive to provide access to such data, as discussed further herein. In various embodiments, NFTs may thus indicate ownership or access to sets or subsets of confidential data (whether stored in a unitary data vault or in a plurality of distributed data storage locations), or NFTs may include confidential data within the FNTs themselves.

The processor 104 may execute the NFT upload module 210a to, for example, cause the processor 104 to upload an NFT to a confidential data management system (block 210b). For example, the process 104 may upload an NFT to a hub on a blockchain or cloud-based platform (e.g., system 100 of FIG. 1).

The processor 104 may execute the confidential data access control module 212a to, for example, cause the processor 104 to control interaction with confidential data in real-time (block 212b). For example, the processor 104 may control availability of confidential data to a third-party based upon a request from the third-party. Alternatively, or additionally, the processor 104 may control a timed security key. The timed security key may provide specific access to specific stakeholders for a specified time interval. In some embodiments, the timed security key may be revoked prior to expiration of the specified time interval to limit access to the confidential data. The specific access may be, for example, access to use the specific confidential data, access to save the specific confidential data, access to specific confidential data with rights reserved, etc.

The processor 104 may execute the curated data packaging module 213a to, for example, cause the processor 104 to curate the specific confidential data and/or permissions associated with the specific confidential data (block 213b). For example, the processor 104 may package the specific confidential data and/or permissions associated with the specific confidential data with an NFT.

It should further be noted that the method 200b may include additional, less, alternate actions, or actions in alternate order including those discussed elsewhere herein.

FIG. 2C illustrates an exemplary computer-implemented method 200c for limiting availability of confidential data 208c, including business confidential data 208c1 and consumer confidential data 208c2. The method 200c may be implemented by a processor (e.g., processor(s) 104 of FIG. 1) executing, for example, at least a portion of modules 208a-216a of FIG. 2A. In particular, processor 104 may execute the confidential data receiving module 208a to cause the processor 104 to, for example, receive confidential data (block 208c).

The processor 104 may execute the non-fungible token (NFT) minting module 209a to, for example, cause the processor 104 to mint an NFT based upon the confidential data (block 209c). For example, the processor 104 may package confidential data and descriptions in an NFT based upon confidential data and/or permissions to interact with the confidential data. Alternatively, or additionally, the processor 104 may package confidential data and descriptions in an NFT along with real-time permissions to interact with the confidential data.

The processor 104 may execute the NFT upload module 210a to, for example, cause the processor 104 to upload an NFT to a confidential data management system (block 210c). For example, the process 104 may upload an NFT to a hub on a blockchain or cloud-based platform (e.g., system 100 of FIG. 1).

The processor 104 may execute the confidential data access request receiving module 211a to, for example, cause the processor 104 to receive a request for interaction with confidential data (block 211c). For example, the processor 104 may receive a request for access to specific confidential data from a third-party.

The processor 104 may execute the confidential data access control module 212a to, for example, cause the processor 104 to control interaction with confidential data in real-time (block 212c). For example, the processor 104 may control availability of confidential data to a third-party based upon a request from the third-party. Alternatively, or additionally, the processor 104 may control a timed security key. The timed security key may provide specific access to specific stakeholders. The specific access may be, for example, access to use the specific confidential data, access to save the specific confidential data, access to specific confidential data with rights reserved, etc.

The processor 104 may execute the curated data packaging module 213a to, for example, cause the processor 104 to curate the specific confidential data and/or permissions associated with the specific confidential data (block 213c). For example, the processor 104 may package the specific confidential data and/or permissions associated with the specific confidential data with an NFT.

The processor 104 may execute the confidential data access security module 214a to, for example, cause the processor 104 to manually and/or automatically control interaction with confidential data (block 214c). For example, the processor 104 may turn confidential data access on/off either on demand or autonomously if security concerns exist.

The processor 104 may execute the confidential data third party access module 215a to, for example, cause the processor 104 to unpack an NFT (block 215c). For example, the processor 104 may access confidential data for a specific stakeholder by unpacking an associated NFT.

The processor 104 may execute the confidential data interaction module 216a to, for example, cause the processor 104 to upload an NFT to a confidential data management system (block 216c).

It should further be noted that the method 200c may include additional, less, alternate actions, or actions in alternate order including those discussed elsewhere herein.

### Exemplary System and Method for Real-Time Management of Consumer Data Permissions

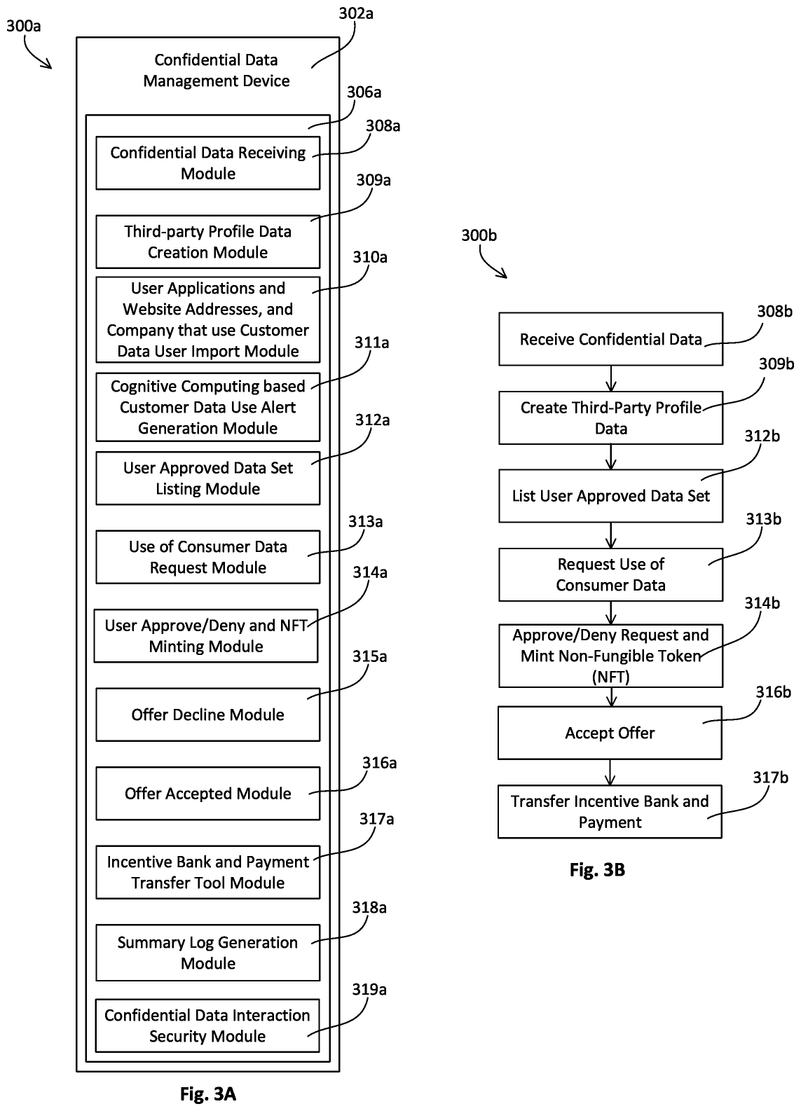

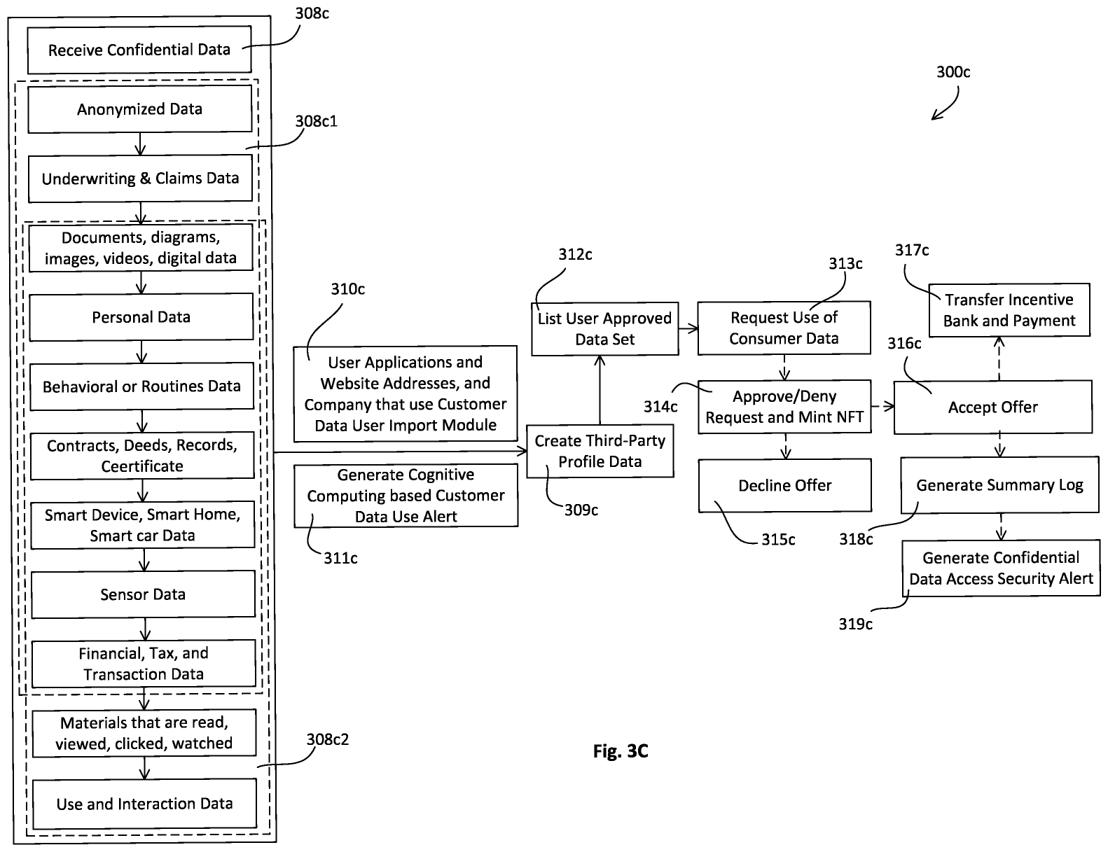

FIG. 3A illustrates an exemplary confidential data management device 302a. The confidential data management device 302a may be similar to, for example, the business device 102 of FIG. 1. The confidential data management device 302a may, for example, provide real-time management of consumer data permissions (e.g., consumer confidential data 308c2 of FIG. 3C, etc.).

The confidential data management device 302a may include a confidential data receiving module 308a, a third-party profile data creation module 309a, a user applications and website addresses, and company that use customer data user import module 310a, a cognitive computing based customer data user alert generation module 311a, a user approved data set listing module 312a, a user of consumer data request module 313a, a user approve/deny and NFT minting module 314a, an offer decline module 315a, an offer accepted module 316a, an incentive bank and payment transfer tool module 317a, a summary log generation module 318a, and a confidential data access security module 319a, for example, stored on a memory 306a as a set of computer-readable instructions. At least a portion of the modules 308a-319a may be included within the confidential data management module 108 of FIG. 1.

FIG. 3B illustrates an exemplary method 300b for real-time management of consumer data permissions. The method 200b may be implemented by a processor (e.g., processor(s) 104 of FIG. 1) executing, for example, at least a portion of modules 308a-319a of FIG. 3A. In particular, processor 104 may execute the confidential data receiving module 308a to cause the processor 104 to, for example, receive confidential data (block 308b). The confidential data may be, for example, consumer data (e.g., a document, a diagram, an image, a video, digital data, materials that are read, materials that are viewed, materials that are clicked, materials that are watched, materials that are used, interaction data, personal data, behavioral data, routine data, a contract, a deed, a record, a certificate, smart device data, smart home data, smart car data, sensor data, financial data, tax data, transaction data, etc.).

The processor 104 may execute the third-party profile data creation module 309a to, for example, cause the processor 104 to create third-party profile data (block 309b). For example, the processor 104 may create third-party profile data via a confidential data management permissions portal. The processor 104 may generate a message to a third-party notifying the third-party that that the portal is holding confidential data permissions to a user's data access.

The processor 104 may execute the user approved data set listing module 312a to, for example, cause the processor 104 to list user approved data sets (block 312b). For example, the processor 104 may list user approved data sets in each third-party profile. The processor 104 may host the listed confidential data on an encrypted blockchain data permissions platform.

The processor 104 may execute the user approve/deny and NFT minting module 314a to, for example, cause the processor 104 to receive an approve/deny toggle (block 314b), which may indicate data to be accessed and/or conditions or terms of such access. For example, the processor 104 may receive a user controlled approve/deny toggle, an on-demand access toggle, a timed access toggle, etc. An approve/deny toggle may provide specific access to specific stakeholders. Alternatively, or additionally, an approve/deny toggle may provide at least one of: confidential data use access, confidential data save access, confidential data access with rights reserved, confidential data access via a smart-contract, etc. As another alternative, or addition, an approve/deny toggle may provide acceptance/denial of a confidential data use incentive.

The processor 104 may execute the offer accepted module 316a to, for example, cause the processor 104 to receive and process an offer acceptance (block 316b). For example, the processor 104 may toggle specific data use on for specific third-party requester. Alternatively, or additionally, the processor 104 may toggle data access on for a specific time frame or until denied. In any event, the processor 104 may automatically send an associated message to the third-party.

The processor 104 may execute the incentive bank and payment transfer tool module 317a to, for example, cause the processor 104 to transfer a confidential data interaction incentive (block 317b). For example, the processor 104 may transfer an incentive via a bank and/or a payment tool.

It should further be noted that the method 300c may include additional, less, alternate actions, or actions in an alternate order including those discussed elsewhere herein.

FIG. 3C illustrates an exemplary computer-implemented method 300c for real-time management of consumer data permissions. The method 300c may be implemented by a processor (e.g., processor(s) 104 of FIG. 1) executing, for example, at least a portion of modules 308a-319a of FIG. 3A. In particular, processor 104 may execute the confidential data receiving module 308a to cause the processor 104 to, for example, receive confidential data (block 308c).

The processor 104 may execute the third-party profile data creation module 309a to, for example, cause the processor 104 to create third-party profile data (block 309c). For example, the processor 104 may create third-party profile data via a confidential data management permissions portal. The processor 104 may generate a message to a third-party notifying the third-party that that the portal is holding confidential data permissions to a user's data access.

The processor 104 may execute the user applications and website addresses, and company that use customer data user import module 310a to, for example, cause the processor 104 to import user applications, website addresses, and companies that use customer data (block 310c). For example, the processor 104 may import apps, website addresses, and companies that use customer data (e.g., social media, banks, smart devices, sensors, etc.) to a confidential data management system 100 and/or a user profile.

The processor 104 may execute the cognitive computing based customer data user alert generation module 311a to, for example, cause the processor 104 to implement a cognitive computing-based analysis of the confidential data (block 311c), which may include generating customer data use alerts as appropriate. For example, the processor 104 may implement cognitive computing-based scans for available customer data and may alert a customer of companies/apps using the data. The processor 104 may automatically import associated results of a cognitive computing-based analysis to a confidential data management system 100.

The processor 104 may execute the user approved data set listing module 312a to, for example, cause the processor 104 to list user approved data sets (block 312c). For example, the processor 104 may list user approved data sets in each third-party profile. The processor 104 may host the listed confidential data on an encrypted blockchain data permissions platform.

The processor 104 may execute the user of consumer data request module 313a to, for example, cause the processor 104 to receive a request for interaction with confidential data from a third-party (block 313c). For example, the processor 104 may receive a request for use of specific consumer data for specific uses and may offer corresponding incentives. The processor 104 may automatically send a notification to an associated user.

The processor 104 may execute the user approve/deny and NFT minting module 314a to, for example, cause the processor 104 to receive an approve/deny toggle (block 314c). For example, the processor 104 may receive a user controlled approve/deny toggle, an on-demand access toggle, a timed access toggle, etc. An approve/deny toggle may provide specific access to specific stakeholders. Alternatively, or additionally, an approve/deny toggle may provide at least one of: confidential data use access, confidential data save access, confidential data access with rights reserved, confidential data access via a smart-contract, etc. As another alternative, or addition, an approve/deny toggle may provide acceptance/denial of a confidential data use incentive.

The processor 104 may execute the offer decline module 315a to, for example, cause the processor 104 to receive an offer declination (block 315c). For example, the processor 104 may toggle a data use off/deny for specific data use. The processor 104 may automatically send a message to an associated user.

The processor 104 may execute the offer accepted module 316a to, for example, cause the processor 104 to receive an offer acceptance (block 316c). For example, the processor 104 may toggle specific data use on for specific third-party requester. Alternatively, or additionally, the processor 104 may toggle data access on for a specific time frame or until denied. In any event, the processor 104 may automatically send an associated message to the third-party.

The processor 104 may execute the incentive bank and payment transfer tool module 317a to, for example, cause the processor 104 to transfer a confidential data interaction incentive (block 317c). For example, the processor 104 may transfer an incentive via a bank and/or a payment tool.

The processor 104 may execute the summary log generation module 318a to, for example, cause the processor 104 to generate a summary log associated with confidential data interaction(s) (block 318c). For example, the processor 104 may generate a contract and use, data interactions, data exchanges, and transactions logs.

The processor 104 may execute the confidential data access security module 319a to, for example, cause the processor 104 to turn data interaction on and/or off (block 319c). For example, the processor 104 may turn data access on/off either on demand or autonomously if security concerns exist or use right end.

It should further be noted that the method 300c may include additional, less, alternate actions, or actions in an alternate order including those discussed elsewhere herein.

### Exemplary Distributed Ledgers for Managing Confidential Data

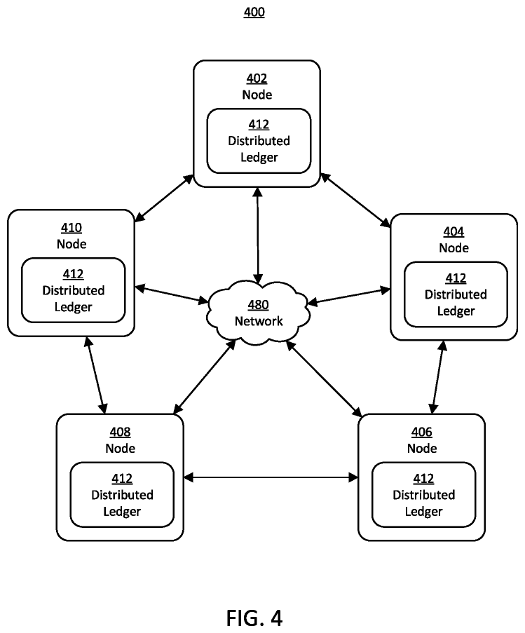

FIG. 4 depicts an exemplary distributed ledger system 400 for managing confidential data. The system 400 may include a distributed ledger 412 (e.g., having one or more distributed ledger layers) and a plurality of nodes 402, 404, 406, 408, and 410 (e.g., each similar to node 102 or 150 of FIG. 1). Each node maintains a copy of the distributed ledger 412. As changes are made to the distributed ledger 412, each node receives the change via the network 480 and updates its respective copy of the distributed ledger 412. A consensus mechanism may be used by the nodes 402-410 in the distributed ledger system 400 to decide whether it is appropriate to make received changes to the distributed ledger 412 or to a particular layer of the distributed ledger 412.

Each node in the system therefore has its own copy of the distributed ledger 412, which is identical to every other copy of the distributed ledger 412 stored by the other nodes. The distributed ledger system 400 may be more robust than a central authority database system because of the distributed ledger's decentralized nature. As such, there is no single point of failure on the distributed ledger system 400 as there would be in a centralized system.

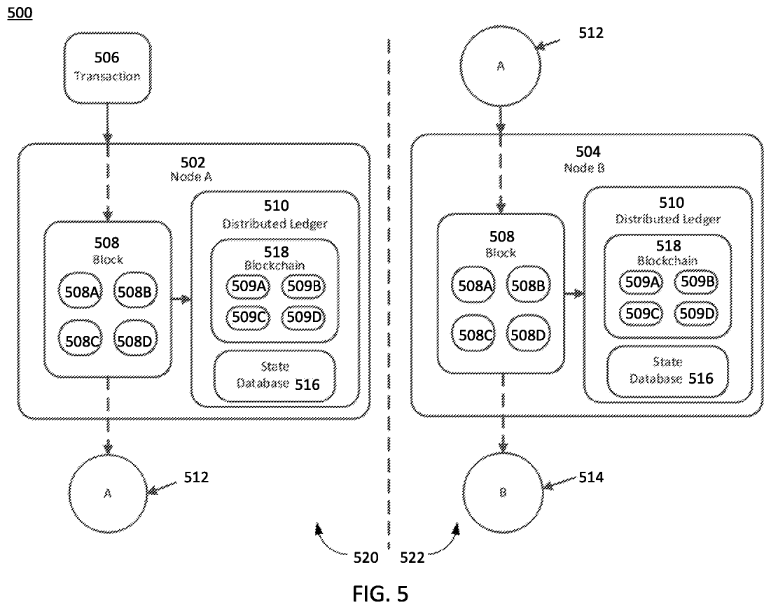

FIG. 5 depicts exemplary network nodes and an exemplary transaction flow 500 on a distributed ledger network for managing confidential data. FIG. 5 includes two time frames 520 and 522 represented by the left and right sides of the dotted line, respectively, Node A 502 (e.g., node 102) and Node B 504 (e.g., node 150), a set of transactions 508A-508D, a set of blocks of transactions 509A-509D, a distributed ledger 510, and a blockchain 518.

The block propagation flow 500 may begin with Node A 502 receiving transaction 506 at time 520. When Node A 502 confirms that transaction 506 is valid, Node A 502 may add the transaction to a newly generated block 508. As part of adding the transaction 506 to block 508, Node A 502 may solve a cryptographic puzzle and include the solution in the newly generated block 508 as proof of the work done to generate the block 508. Alternatively, a proof of stake algorithm may be used to generate the block 508, whereby Node A 502 “stakes” an amount of a digital token used on the network, however, the network itself determines the node that will mint the new block. In another implementation, a proof of authority (PoA) algorithm may be used to generate the block 508, where transactions and blocks are validated by approved accounts, known as validators which run software allowing them to record transactions in the distributed ledger.

In other embodiments, the transaction 506 may be added to a pool of transactions until a sufficient number of transactions in the pool exist to form a block or distributed ledger entry. Node A 502 may transmit the newly created distributed ledger entry 508 to the network at time 512. Before or after propagating the distributed ledger entry 508, Node A 502 may add the distributed ledger entry 508 to its copy of the blockchain 518.

While proof of work, proof of stake, and proof of authority are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of weight, Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the transactions 509A-509D may include updates to a state database 516. The state database 516 may contain current values of variables created by smart contracts deployed on the blockchain 518. Validated distributed ledger entries, such as distributed ledger entry 508, may include transactions effecting state variables in state database 516. At time 522, Node B 504 may receive the newly created distributed ledger entry 508 via the network at 512. Node B 504 may verify that the distributed ledger entry 508 is valid by checking the solution to the cryptographic puzzle provided in the distributed ledger entry 508. If the solution is accurate, then Node B 504 may add the distributed ledger entry 508 to its blockchain 518 and make any updates to the state database 516 as rejected by the transactions in distributed ledger entry 508. Node B 504 may then transmit the distributed ledger entry 508 to the rest of the network at time 514.

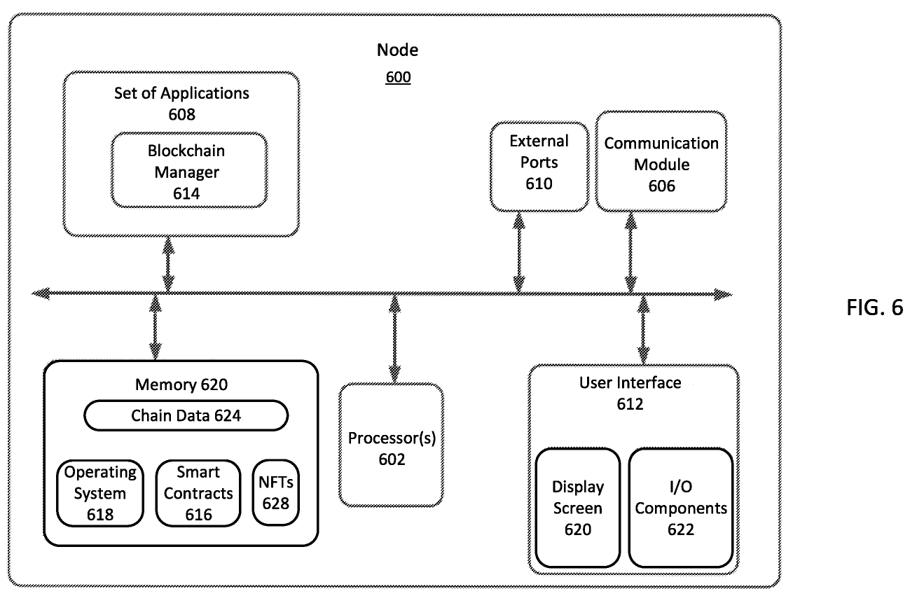

FIG. 6 depicts exemplary components of a network node 600 on a distributed ledger network for managing confidential data. The network node 600 may be similar to the network nodes 102, 150 described above with reference to FIG. 1. Network node 600 may include at least one processor 602, memory 604, a communication module 606 such as a transceiver, a set of applications 608, external ports 610, a blockchain manager 614, smart contracts 616, NFTs 628, an operating system 618, user interface 612, display screen 620, and/or I/O components 622. In some embodiments, the network node 600 may generate a new block of transactions, or may broadcast transactions to other network nodes via the communication module 606 by using the blockchain manager 614. Similarly, the network node 600 may use the blockchain manager 614 in conjunction with the NFTs 628 and/or the smart contracts 616 stored in the memory 604 to provide the functionality disclosed herein. The memory 604 may further include chain data 624 including, for example, a state database of the blockchain for storing states of smart contracts deployed thereon.

In other embodiments, the smart contracts 616 operate independent of the blockchain manager 614 or other applications. In some embodiments, the network node 600 does not have a blockchain manager 614, NFTs 628, or smart contracts 616 stored at the network node. In some embodiments, the network node 600 may have additional or fewer components than described.

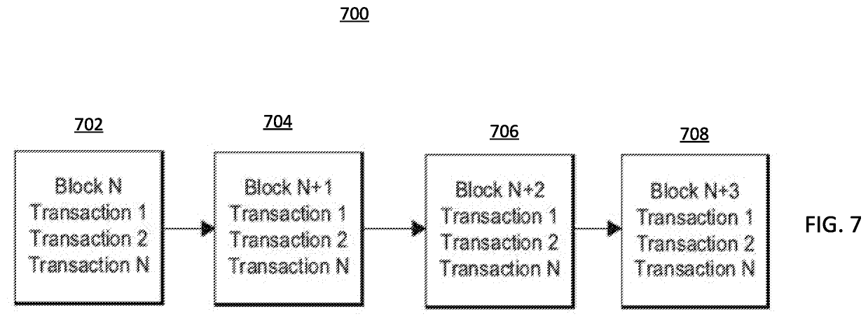

FIG. 7 depicts an exemplary distributed ledger 700 similar to the distributed ledger 190 as shown in FIG. 1. The example distributed ledger 700 includes a blockchain having blocks 702, 704, 706, 708 of transactions. In some embodiments, the blockchain 700 includes several blocks 702-708 connected together to form a chain of blocks 702-708 of transactions. To cryptographically link blocks and transactions together, each block in the blockchain 700 organizes its transactions into a Merkle Tree. In a Merkle Tree each transaction is hashed according to a cryptographic hashing algorithm (e.g., SHA-256) and the resulting output hash is then combined with the hash of another transaction. Then, the combined result may also be hashed according to the cryptographic hashing algorithm. This output is then combined with the hash of two other transactions and this process is repeated until all of the transactions in the block are combined and hashed to generate a Merkle root that is used in the header for a block 702-708. If any single transaction in the block is tampered with, a different Merkle root would be generated since the Merkle root is a combination of the hashes of all of the transactions in the block.

In other words, the transactions may be hashed using a cryptographic hash algorithm, such as the algorithms discussed above, and the hash of each transaction may be stored in the tree. As the tree is constructed the hash of each adjacent node at the same level may be hashed together to create a new node that exists at a higher level in the tree. Therefore, the node at the top of the tree or Merkle root, is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, confidential data information, smart contract information, etc.).

To verify that a block is valid, a network node may compare the Merkle root of the block to the Merkle root for the same block included in other network nodes' copies of the blockchain. Thus, the Merkle root can be used as proof of the transactions included in the block and as proof that the contents of the block have not been tampered with if the Merkle root is the same in each network node's copy of the block.

In one implementation, documents or other data records stored “on” a blockchain are documents or data records that have been hashed according to a cryptographic hashing algorithm (e.g., SHA-256) and the resulting output hash has been included in a transaction in a block that has been accepted by the network nodes as satisfying the consensus rules of the blockchain. As such, the documents or data records may be later verified or validated by comparing the hash of the documents to the hash stored on the blockchain. For example, if a set of data files results in a SHA-256 hash that was recorded on a blockchain on a certain date, then the blockchain provides cryptographic proof that the data files existed as of that date.

One way of storing a document or other data record on a blockchain is to broadcast a transaction including a hash of the document or record to the network, which will be included in a block if the transaction satisfies all of the consensus rules of the network. In some implementations, the blockchain is a permissioned ledger, meaning only authorized network participants may broadcast transactions. In other implementations, only some authorized network participants may make certain transactions. Only a cryptographic hash of the data may be included in the blockchain 700, such that the data may be verified using the blockchain even if it is obtained by a party off-chain.

Network nodes may verify that the signed transaction or signed message was signed by the private cryptographic key corresponding to the published public cryptographic key owned by the user generating the transaction. In at least one implementation, a valid proof-of-identity may be applied as a consensus rule by the blockchain network. Each owner may be assigned a public key/private key pair which is identified in the blockchain network as corresponding to the owner. If the network nodes receive a transaction that is not from an authorized owner, the network nodes reject the transaction.

In some implementations, the blockchain 700 is a public blockchain meaning that any party may view the distributed ledger, submit new information to be added to the ledger, or join the network as a network node. The distributed ledger may also include side chains which are private or permissioned blockchains that keep chain data private among a group of entities authorized to participate in the side blockchain network. In other embodiments, the main blockchain 700 is also a permissioned blockchain but the main blockchain 700 has a larger number of entities authorized to participate in the blockchain network than the side chains.

In addition to protecting privacy via side chains, in some embodiments, privacy may be preserved on the main blockchain 700. For example, the transactions in the blockchain 700 may obfuscate the identities of the parties to the transaction and the transaction amounts through various encryption techniques.

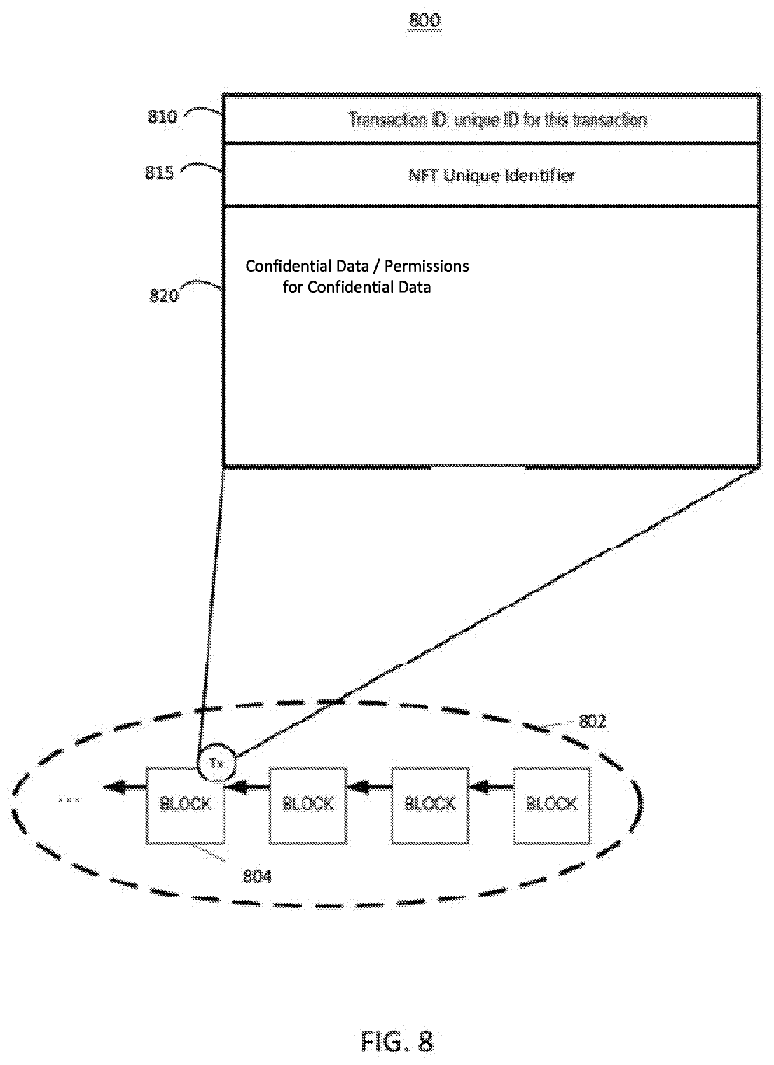

FIG. 8 depicts an exemplary transaction 800 on a distributed ledger network for minting an NFT in accordance with one aspect of the present disclosure. The transaction 800 may mint a new NFT to represent ownership of a confidential data. An originator of the transaction 800 may broadcast the transaction to nodes on the blockchain network and the transaction 800 will be included in block 804 if it is a valid transaction.

The transaction 800 may include various information 806. For example, the transaction 800 may include a transaction ID 810, an NFT unique identifier 815 such as a token identifier, a smart contract address for the NFT, and/or confidential data information 820 (e.g., a set of properties held by the NFT).

The confidential data information 820 may include any suitable information, such as identification information of the confidential data. The identification information of the confidential data may include a description of the confidential data, a resource locator of the confidential data (e.g., a virtual address where the confidential data is stored), one or more data sets or files containing the confidential data in a structured format, access credentials to obtain the confidential data (e.g., a secure token or cryptographic key providing access to certain confidential data), toggles or flags indicating access to certain confidential data by identified users, conditional requirements for access to confidential data (e.g., time restrictions, local restrictions, or conditional logic), etc. Furthermore, in some embodiments, the NFT represents ownership and/or possession of more than one set of confidential data 130; and, in some of these embodiments, the confidential data information 820 may include information of more than one set of confidential data 130.

In some embodiments, the confidential data information 820 may be used to verify receipt of the confidential data. For example, a smart contract may receive an image of the confidential data 130 from the receiving party 120. If information from the received image maps correctly (e.g., within a predetermined tolerance) to information from the confidential data information 820 (e.g., item dimensions from the image and the confidential data information 820 match within a predetermined tolerance), the smart contract may transfer the NFT to the receiving party 120 to indicate that the receiving party 120 possesses the confidential data 130.

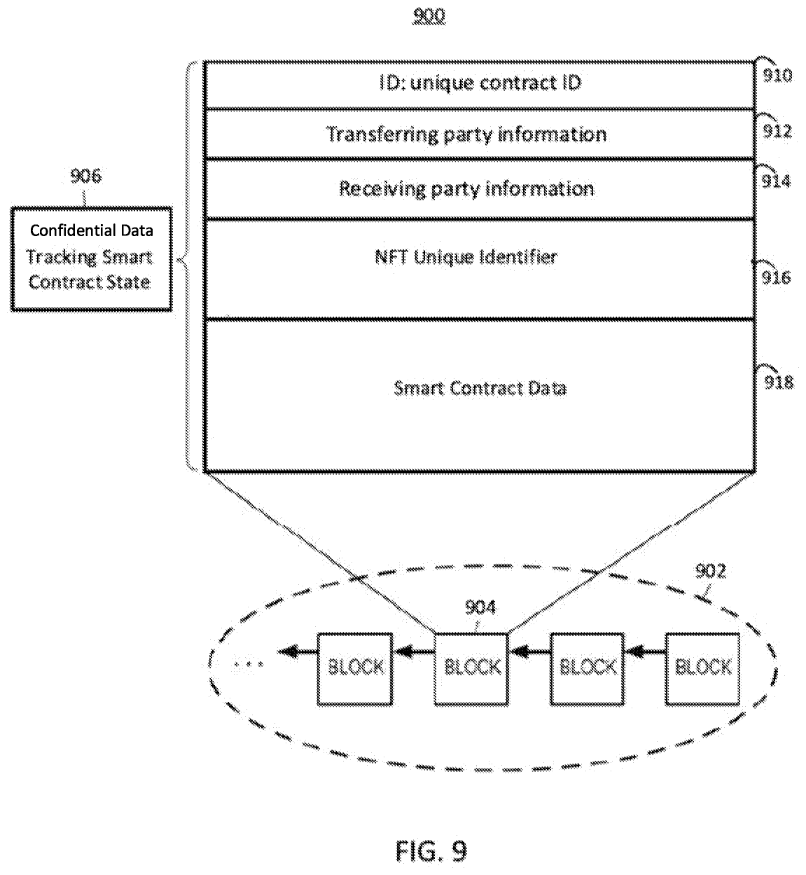

FIG. 9 depicts an exemplary smart contract state 900 in a distributed ledger network for managing confidential data using NFTs. One way of altering the confidential data is via a smart contract state 906 to broadcast a transaction to the blockchain 902. If the broadcast transaction satisfies consensus rules, network nodes may include the transaction in a block 904. Inclusion in the blockchain 902 of a transaction sending data to the smart contract may cause network nodes to update a state database (e.g., a database containing access states relating to sets of confidential data), thus allowing network participants access to a rich state mechanism to manage confidential data.

In some implementations, the block of transactions 904 may organize the transactions it has received into a Merkle Tree to facilitate access to the stored transactions. The transactions may be hashed using a cryptographic hash algorithm, such as the algorithms discussed above, and the hash of each transaction may be stored in the tree. As the tree is constructed the hash of each adjacent node at the same level may be hashed together to create a new node that exists at a higher level in the tree. Therefore, the root of the tree, or the node at the top of the tree, is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

A confidential data smart contract state 906 may include pieces of data to track the confidential data 130. For example, the confidential data smart contract state 906 may include a unique contract ID 910. The confidential data smart contract state 906 may further include transferring party information 912 (e.g., the name of the transferring party; if the transferring party is an individual, or a corporation; etc.). The confidential data smart contract state 906 may further include receiving party information 914 (e.g., the name of the receiving party; if the receiving party is an individual, or a corporation; etc.).

In at least one implementation, the transferring party 140 and the receiving party 120 are identified by cryptographic public keys assigned to the respective entities. Subsequent data sent to the smart contract may include a message signed by private keys corresponding to the public keys identifying the transferring party 140 and the receiving party 120 in the smart contract, thus providing cryptographic proof that the transaction was originated by one of the parties. The private and public keys may be managed solely by the parties to minimize the attack surface for any attackers that might attempt to forge a transaction (e.g., the parties generate public/private cryptographic key pairs offline and only provide the public key to other network participants). A party's private keys may be generated according to a securely stored seed value (e.g., on a piece of physical paper or multiple copies of a piece of paper) such that the private keys may be recovered in the case of a data loss.

The confidential data smart contract state 906 may further include the NFT unique identifier 916 (e.g., 815 of FIG. 8, etc.), such as a token ID associated with a particular smart contract for minting the NFT, where the particular smart contract has a smart contract address.

The confidential data smart contract state 906 may further include smart contract data 918, which may comprise any kind of data. For example, the smart contract data may include terms of a contract between the receiving party 120 and the transferring party 140 (e.g., price of the confidential data, payment terms of purchasing the confidential data, warranty information of the confidential data, access information of the confidential data, a maximum amount of time to access the confidential data, etc.). In another example, the smart contract data 918 includes actions to be taken (e.g., possibly automatically executed by the smart contract) when conditions are met. For example, the smart contract may initiate a transfer of funds (e.g., in cryptocurrency and/or traditional currency) or a transfer of the NFT upon receipt of the indication that the receiving party has received the confidential data.

The smart contract data 918 may include any other kind of data as well. For example, the smart contract data 918 may include data indicating that the confidential data has been received by the receiving party 120. For example, the confidential data smart contract state 906 may include input data from either of the sensors 122, 142. In another example, the smart contract data 918 includes the identification information of the confidential data.

Further regarding the discussion of both FIGS. 8 and 9, it should be noted that the distributed ledgers 802, 902 may transfer the NFTs by any suitable technique. For example, the transferring party 140 may submit a transaction (e.g., Tx of FIG. 8) to a network node to transfer the NFT, and a network node may then record the transaction.

In another example, the NFT may be held by a smart contract (e.g., the NFT is held in escrow by the smart contract until an incentive payment is complete). Either the transferring party 140 or the receiving party 120 may then submit data to the smart contract indicating fulfillment of the smart contract conditions. The smart contract may then review the submitted data to determine if the NFT should be transferred to the receiving party 120. If so, the smart contract may transfer the NFT to the receiving party 120 to indicate possession and/or ownership of the confidential data 130. In this regard, the smart contract data 918 may include the conditions upon which the NFT may be transferred to the receiving party 120. The smart contract data 918 may further include a machine learning algorithm to analyze the uploaded data to determine if the confidential data 130 has been received.

### Exemplary System and Method for Analyzing Confidential Data Using Cognitive Computing

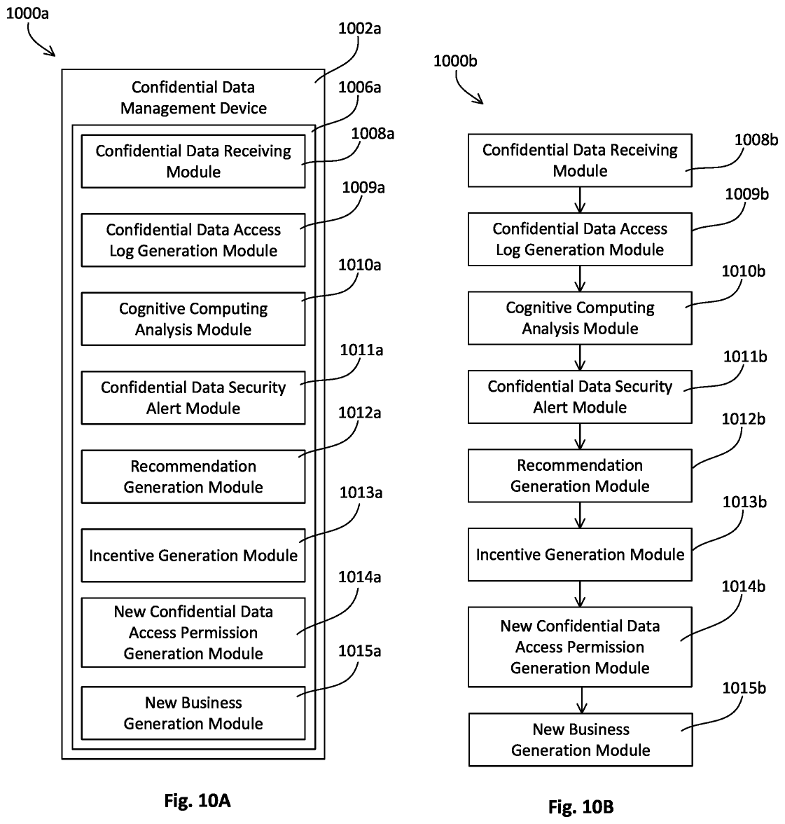

FIG. 10A illustrates an exemplary confidential data management device 1002a. The confidential data management device 1002a may be similar to, for example, the business device 102 of FIG. 1. The confidential data management device 1002a may, for example, access and analyze confidential data (e.g., business confidential data, consumer data, consumer confidential data, etc.).

The confidential data management device 1002a may include a confidential data receiving module 1008a, a confidential data access log generation module 1009a, a cognitive computing analysis module 1010a, a confidential data security alert module 1011a, a recommendations generation module 1012a, an incentive generation module 1013a, a new confidential data access permission generation module 1014a, and a new business generation module 1015a, for example, stored on a memory 206a as a set of computer-readable instructions. At least a portion of the modules 1008a-1015a may be included within the confidential data management module 108 of FIG. 1.

FIG. 10B illustrates an exemplary computer-implemented method 1000b for analyzing confidential data. The method 1000b may be implemented by a processor (e.g., processor(s) 104 of FIG. 1) executing, for example, at least a portion of modules 1008a-1015a of FIG. 10A. In particular, processor 104 may execute the confidential data receiving module 1008a to cause the processor 104 to, for example, receive confidential data (block 1008b). The confidential data may be, for example, business confidential data (e.g., a document, a diagram, an image, a video, digital data, anonymized data, underwriting and claims data, personal data, behavioral data, routine data, a contract, a deed, a record, a certificate, smart device data, smart home data, smart car data, sensor data, financial data, tax data, transaction data, etc.).

The processor 104 may execute the confidential data access log generation module 1009a to cause the processor 104 to, for example, generate a confidential data interaction log based upon interactions with the confidential data and using cognitive computing (block 1009b). The processor 104 may execute the cognitive computing analysis module 1010a to cause the processor 104 to, for example, analyze the confidential data using cognitive computing processes (block 1010b). For example, one or more machine learning models may be applied to the confidential data to generate data insights or recommendations, such as by identifying connections between variables. In some embodiments, an additional data set including public or proprietary data of the analyzing entity may be combined with a confidential data set accessed with one or more NFTs as described herein, such that the cognitive computing analysis may be performed on both data sets. The processor 104 may execute the confidential data security alert module 1011a to cause the processor 104 to, for example, generate a confidential data security alert based upon interactions with the confidential data and using cognitive computing (block 1011b).

The processor 104 may execute the recommendations generation module 1012a to cause the processor 104 to, for example, generate a recommendation based upon the confidential data and/or interactions with the confidential data and using cognitive computing (block 1012b). The processor 104 may execute the incentive generation module 1013a to cause the processor 104 to, for example, generate an incentive based upon the confidential data and/or interactions with the confidential data and using cognitive computing (block 1013b).

The processor 104 may execute the new confidential data access permission generation module 1014a to cause the processor 104 to, for example, generate a new confidential data access permission based upon the confidential data and/or interactions with the confidential data and using cognitive computing (block 1014b). The processor 104 may execute the new business generation module 1015a to cause the processor 104 to, for example, generate new business based upon the confidential data and/or interactions with the confidential data and using cognitive computing (block 1015b).

It should further be noted that the method 1000b may include additional, less, alternate actions, or actions in a different order including those discussed elsewhere herein.

### Applicability to the Insurance Industry

Some embodiments have particular applicability to the insurance industry. For example, customers may receive discounts to insurance premiums if they opt into programs in accordance with the techniques described herein. For instance, if receiving party 120 is an insurance customer, the customer may receive a discount on an insurance premium by agreeing to manage confidential data 130 in accordance with any of the techniques described herein.

### Exemplary Use of NFTs to Manage Confidential Data

In at least one aspect, a computer-implemented method for using NFTs to limit access to confidential data may be provided. The method may be implemented via one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the method may include obtaining, via one or more processors, identification information of confidential data. The method may also include packaging, via the one or more processors, an NFT on a distributed ledger. The NFT may represent ownership of the confidential data and including the identification information of the confidential data. The method may further include receiving, via the one or more processors, an indication providing access to at least one specific stakeholder for specific confidential data within the confidential data. The method may yet further include curating, via the one or more processors, availability of the specific confidential data to the at least one specific stakeholder in response to receiving the indication providing availability of the specific confidential data. The method may include additional, less, or alternative actions, including those discussed elsewhere herein.

For instance, the confidential data may be representative of at least one of: business confidential data, consumer confidential data, a document, a diagram, an image, a video, digital data, anonymized data, underwriting and claims data, personal data, behavioral data, routine data, a contract, a deed, a record, a certificate, smart device data, smart home data, smart car data, sensor data, financial data, tax data, or transaction data.

In at least one aspect, a method may include receiving, via the one or more processors, an indication that the stakeholder has completed a two-factor authentication process, wherein curating availability of the specific confidential data occurs in response to receiving the indication that the stakeholder has completed the two-factor authentication process.

In at least one aspect, a method may include curating availability of the specific confidential data occurs in response to receiving an indication that the at least one stakeholder has requested the specific confidential data.

In at least one aspect, a method may include receiving, via the one or more processors, an indication that the at least one stakeholder has accessed the specific confidential data. Additionally or alternatively, a method may include monitoring interaction, via the one or more processors, of the at least one specific stakeholder with the specific confidential data.

In at least one aspect, a method may include receiving, via the one or more processors, an indication that at least one security concern exists with respect to the confidential data. Additionally or alternatively, a method may include analyzing, via the one or more processors, the confidential data using a cognitive computing algorithm.

In at least one aspect, a method may include denying availability of the specific confidential data in response to receiving the indication that the at least one security concern exists.

In at least one aspect, a computer system for using NFTs to limit access to confidential data may be provided. The computer system may include one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the computer system may include one or more local or remote processors, transceivers, and/or sensors configured to obtain identification information of confidential data. The computer system may also be configured to mint an NFT on a distributed ledger. The NFT may represent ownership of the confidential data and including the identification information of the confidential data. The computer system may also be configured to receive an indication providing access to at least one specific stakeholder for specific confidential data within the confidential data. The computer system may also be configured to curate availability of the specific confidential data to at least one specific stakeholder in response to receiving the indication providing availability of the specific confidential data. The computer system may be configured to include additional, less, or alternative functionality, including that discussed elsewhere herein.

For instance, the confidential data is representative of at least one of: a document, a diagram, an image, a video, digital data, materials that are read, materials that are viewed, materials that are clicked, materials that are watched, materials that are used, interaction data, personal data, behavioral data, routine data, a contract, a deed, a record, a certificate, smart device data, smart home data, smart car data, sensor data, financial data, tax data, or transaction data.

In at least one aspect, a computer device for using NFTs to limit access to confidential data may include one or more processors and one or more memories coupled to the one or more processors. The one or more memories may include computer executable instructions stored therein that, when executed by the one or more processors, cause the one or more processors to obtain identification information of confidential data. Further execution of the computer executable instructions may also cause the one or more processors to mint an NFT on a distributed ledger. The NFT may represent ownership of the confidential data and include the identification information of the confidential data. Further execution of the computer executable instructions may further cause the one or more processors to receive an indication providing access to at least one specific stakeholder for specific confidential data within the confidential data. Further execution of the computer executable instructions may also cause the one or more processors to curate availability of the specific confidential data to the at least one specific stakeholder in response to receiving the indication providing availability of the specific confidential data. The computer device may be configured to include additional, less, or alternative functionality, including that discussed elsewhere herein.

In at least one aspect, a computer-implemented method for using NFTs for real-time management of data permissions may be provided. The method may be implemented via one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the method may include obtaining, via one or more processors, identification information of confidential data. The method may also include creating, via the one or more processors, third-party profile via a data permissions platform. The method may further include listing, via the one or more processors, user approved confidential data with the third-party profile in response to creation of the third-party profile. The method may yet further include receiving, via the one or more processors, a data use incentive offer from the third-party in exchange for specific confidential data availability. The method may also include minting, via the one or more processors, an NFT on a distributed ledger. The NFT may represent ownership of the confidential data and including the identification information of the specific confidential data. The method may further include transferring, via the one or more processors, the NFT to the third-party in exchange for the data use incentive in response to the user accepting the data use incentive. The method may include additional, less, or alternative actions, including those discussed elsewhere herein.

For instance, the confidential data may be representative of at least one of: a document, a diagram, an image, a video, digital data, materials that are read, materials that are viewed, materials that are clicked, materials that are watched, materials that are used, interaction data, personal data, behavioral data, routine data, a contract, a deed, a record, a certificate, smart device data, smart home data, smart car data, sensor data, financial data, tax data, or transaction data.

In at least one aspect, a computer system for using NFTs to manage data permissions in real-time may be provided. The computer system may include one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the computer system may include one or more local or remote processors, transceivers, and/or sensors configured to obtain identification information of confidential data. The system may be also configured to create a third-party profile via a data permissions platform. The system may be further configured to list user approved confidential data with the third-party profile in response to creation of the third-party profile. The system may be yet further configured to receive a data use incentive offer from the third-party in exchange for specific confidential data availability. The system may be also configured to mint an NFT on a distributed ledger. The NFT may represent ownership of the confidential data and including the identification information of the specific confidential data. The system may be further configured to transfer the NFT to the third-party in exchange for the data use incentive in response to the user accepting the data use incentive. The system may be configured to include additional, less, or alternative functionality, including that discussed elsewhere herein.

In at least one aspect, a computer device for using NFTs to manage data permissions in real-time may include one or more processors and one or more memories coupled to the one or more processors. The one or more memories may include computer executable instructions stored therein that, when executed by the one or more processors, may cause the one or more processors to obtain identification information of confidential data. Further execution of the instructions may also cause the one or more processors to create a third-party profile via a data permissions platform. Further execution of the instructions may further cause the one or more processors to list user approved confidential data with the third-party profile in response to creation of the third-party profile. Further execution of the instructions may yet further cause the one or more processors to receive a data use incentive offer from the third-party in exchange for specific confidential data availability. Further execution of the instructions may also cause the one or more processors to mint an NFT on a distributed ledger, the NFT representing ownership of the confidential data and including the identification information of the specific confidential data. Further execution of the instructions may also cause the one or more processors to transfer the NFT to the third-party in exchange for the data use incentive in response to the user accepting the data use incentive. The computer device may be configured to include additional, less, or alternative functionality, including that discussed elsewhere herein.

In at least one aspect, a computer-implemented method for using cognitive computing for recommendation generation based on confidential data and corresponding NFTs may be provided. The method may be implemented via one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the method may include obtaining, via one or more processors, at least one of: confidential data, interaction permissions for confidential data, or interactions with confidential data. The method may also include generating, via the one or more processors, at least one of: a confidential data interaction security alert, a recommendation, an incentive, a new confidential data interaction permission, or new business based upon the at least one of: confidential data, interaction permissions for confidential data, or interactions with confidential data and using cognitive computing. The method may include additional, less, or alternative actions, including that discussed elsewhere herein.

For instance, the confidential data may be representative of business confidential data, consumer confidential data, a document, a diagram, an image, a video, digital data, anonymized data, underwriting and claims data, personal data, behavioral data, routine data, a contract, a deed, a record, a certificate, smart device data, smart home data, smart car data, sensor data, financial data, tax data, or transaction data.

In at least one aspect, a computer system to generate recommendations based on confidential data and corresponding NFTs using cognitive computing may be provided. The computer system may include one or more local or remote processors, transceivers, sensors, servers, memory units, wearables, smart devices, mobile devices, smart glasses, augmented reality glasses, virtual reality headsets, and/or other electronic or electrical components, which may be in wired or wireless communication over one or more radio frequency links. For example, in one instance, the system may include one or more local or remote processors, transceivers, and/or sensors configured to obtain at least one of: confidential data, interaction permissions for confidential data, or interactions with confidential data. The system may also be configured to generate at least one of: a confidential data interaction security alert, a recommendation, an incentive, a new confidential data interaction permission, or new business based upon the at least one of: confidential data, interaction permissions for confidential data, or interactions with confidential data and using cognitive computing. The system may be configured to include additional, less, or alternative functionality, including that discussed elsewhere herein.

In at least one aspect, a computer device to generate recommendations based on confidential data and corresponding NFTs using cognitive computing may include one or more processors and one or more memories coupled to the one or more processors. The one or more memories may include computer executable instructions stored therein that, when executed by the one or more processors, cause the one or more processors to obtain at least one of: confidential data, interaction permissions for confidential data, or interactions with confidential data. Further execution of the instructions may also cause the one or more processors to generate at least one of: a confidential data interaction security alert, a recommendation, an incentive, a new confidential data interaction permission, or new business based upon the at least one of: confidential data, interaction permissions for confidential data, or interactions with confidential data and using cognitive computing. The computer device may include additional, less, or alternative functionality, including that discussed elsewhere herein.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules.

In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for using non-fungible tokens (NFTs) to limit access to confidential data, the method comprising:
obtaining, via one or more processors, identification information of confidential data;
packaging, via the one or more processors, an NFT on a distributed ledger, the NFT representing ownership of the confidential data and including the identification information of the confidential data;
receiving, via the one or more processors, an indication providing access to at least one specific stakeholder for specific confidential data within the confidential data; and
curating, via the one or more processors, availability of the specific confidential data to the at least one specific stakeholder in response to receiving the indication providing availability of the specific confidential data.

2. The computer-implemented method of claim 1, wherein the confidential data is representative of at least one of: business confidential data, consumer confidential data, a document, a diagram, an image, a video, digital data, anonymized data, underwriting and claims data, personal data, behavioral data, routine data, a contract, a deed, a record, a certificate, smart device data, smart home data, smart car data, sensor data, financial data, tax data, or transaction data.

3. The computer-implemented method of claim 1, further comprising receiving, via the one or more processors, an indication that the stakeholder has completed a two-factor authentication process; and
wherein curating availability of the specific confidential data occurs in response to receiving the indication that the stakeholder has completed the two-factor authentication process.

4. The computer-implemented method of claim 1, wherein curating availability of the specific confidential data occurs in response to receiving an indication that the at least one stakeholder has requested the specific confidential data.

5. The computer-implemented method of claim 1, further comprising:
receiving, via the one or more processors, an indication that the at least one stakeholder has accessed the specific confidential data.

6. The computer-implemented method of claim 1, further comprising:
monitoring, via the one or more processors, interaction of the at least one specific stakeholder with the specific confidential data.

7. The computer-implemented method of claim 1, further comprising:
receiving, via the one or more processors, an indication that at least one security concern exists with respect to the confidential data.

8. The computer-implemented method of claim 7, wherein receiving the indication that the at least one security concern exists comprises:
analyzing, via the one or more processors, the confidential data using a cognitive computing algorithm.

9. The computer-implemented method of claim 7, wherein availability of the specific confidential data is denied in response to receiving the indication that the at least one security concern exists.

10. A computer system for using non-fungible tokens (NFTs) to limit access to confidential data, the computer system comprising one or more local or remote processors, transceivers, and/or sensors configured to:
obtain identification information of confidential data;
mint an NFT on a distributed ledger, the NFT representing ownership of the confidential data and including the identification information of the confidential data;
receive an indication providing access to at least one specific stakeholder for specific confidential data within the confidential data; and
curate availability of the specific confidential data to at least one specific stakeholder in response to receiving the indication providing availability of the specific confidential data.

11. The computer system of claim 10, wherein the confidential data is representative of at least one of: a document, a diagram, an image, a video, digital data, materials that are read, materials that are viewed, materials that are clicked, materials that are watched, materials that are used, interaction data, personal data, behavioral data, routine data, a contract, a deed, a record, a certificate, smart device data, smart home data, smart car data, sensor data, financial data, tax data, or transaction data.

12. The computer system of claim 10, wherein the one or more local or remote processors, transceivers, and/or sensors are further configured to:
receive an indication that a title holder of the confidential data has completed a two-factor authentication process; and
mint the NFT in response to receiving the indication that the title holder of the confidential data has completed the two-factor authentication process.

13. The computer system of claim 10, wherein the one or more local or remote processors, transceivers, and/or sensors are further configured to execute a smart contract to cause transferring the NFT to the receiving party to indicate that the receiving party possesses the confidential data.

14. The computer system of claim 10, wherein the one or more local or remote processors, transceivers, and/or sensors are further configured to:
receive a request to interact with the confidential data.

15. The computer system of claim 10, wherein the one or more local or remote processors, transceivers, and/or sensors are further configured to:
generate a confidential data interaction alert based upon an attempted interaction with the confidential data.

16. A non-transitory computer-readable medium including computer-executable instructions stored therein that, when executed by the one or more processors, cause the one or more processors to use non-fungible tokens (NFTs) to limit access to confidential data and to:
obtain identification information of confidential data;
mint an NFT on a distributed ledger, the NFT representing ownership of the confidential data and including the identification information of the confidential data;
receive an indication providing access to at least one specific stakeholder for specific confidential data within the confidential data; and
curate availability of the specific confidential data to the at least one specific stakeholder in response to receiving the indication providing availability of the specific confidential data.

17. The computer-readable medium of claim 16, wherein the confidential data includes at least one of: business confidential data, consumer data, or customer confidential data.

18. The computer-readable medium of claim 16, wherein the one or more memories include computer executable instructions stored therein that, when executed by the one or more processors, further cause the one or more processors to:
receive an indication that a third-party has interacted with the confidential data.

19. The computer-readable medium of claim 16, wherein the one or more memories include computer executable instructions stored therein that, when executed by the one or more processors, further cause the one or more processors to execute a smart contract to cause transferring the NFT to a receiving party to indicate that the receiving party possesses the confidential data.

20. The computer-readable medium of claim 16, wherein further execution of the instructions by the one or more processors, further cause the one or more processors to:
log an interaction with the confidential data.
